(19) United States
(12) Patent Application Publication
(10) Pub. No.: US 2004/0102539 A1
(43) Pub. Date: May 27, 2004

(54) Laser sintering powder with improved recycling properties, process for its production, and use of the laser sintering powder

(75) Inventors: Sylvia Monsheimer, Haltern am See (DE); Maik Grebe, Bochum (DE); Franz-Erich Baumann, Duelmen (DE); Wolfgang Christoph, Marl (DE); Thomas Schiffer, Haltern am See (DE); Heinz Scholten, Haltern am See (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/637,613

(22) Filed: Aug. 11, 2003

(30) Foreign Application Priority Data
Oct. 17, 2002 (DE) 102 48 407.4
Jul. 7, 2003 (DE) 103 30 590.4

(51) Int. Cl. C08J 3/28

(52) U.S. Cl. 522/2; 528/310; 528/332

(57) ABSTRACT

A laser sintering process produces a body in the shape of a block which contains the desired components and non-irradiated powder which remains with the components in the block until the molding is revealed, or its covering is removed. The non-irradiated powder can be used in a further forming process (recycling) after sieving and addition of virgin powder. The sintering powder includes a polyamide to which organic carboxylic acids have been added as regulators to permit preparation of a polyamide powder with almost constant solution viscosity, capable of repeated use in a laser sintering process without addition of virgin powder.

### BACKGROUND OF THE INVENTION

1. Field of the Invention

The invention relates to a laser sintering powder containing a regulated polyamide, preferably nylon-12, a process for the use of the last sinter powder, and to moldings produced by selective laser sintering of the laser sinter powders.

2. Description of the Related Art

Very recently, a need for the rapid production of prototypes has arisen. Laser sintering is a process particularly well suited to rapid prototyping. In this process, polymer powders are selectively and briefly irradiated in a chamber with a laser beam, resulting in melting of the powder particles which are exposed to the laser beam. The molten particles fuse then solidify to form a solid mass. Complex three-dimensional bodies can be produced simply and relatively rapidly by repeatedly applying fresh layers of powder particles and exposing the fresh layers of powder particles to a laser beam.

The process of laser sintering (rapid prototyping) to realize moldings made from pulverulent polymers is described in detail in U.S. Pat. No. 6,136,948 and WO 96/06881 (both incorporated herein by reference in their entireties). A wide variety of polymers and copolymers are disclosed to be useful in this application including polyacetate, polypropylene, polyethylene, ionomers, and nylon-11.

The laser sintering process produces a body in the shape of a block which contains the desired components and additionally, usually predominantly, non-irradiated powder, known as recycling powder which remains with the components in the block until the molding is revealed, or its covering is removed. This powder supports the components allowing overhangs and undercuts to be produced by the laser sintering process without the use of other supports. Depending on the nature of the powder used, the non-irradiated powder can be used in a further forming process (recycling) after sieving and addition of virgin powder.

Nylon-12 (PA 12) powder has proven particularly well suited for production of engineering components by laser sintering. Parts manufactured from PA 12 powder are able to meet the high requirements specified for mechanical loading, and have properties nearly the same as those of parts produced by mass-production techniques such as extrusion or injection molding.

It is preferable to use a nylon-12 powder whose melting point is from 185 to 189° C., whose enthalpy of fusion is 112±17 kJ/mol, and whose freezing point is from 138 to 143° C., as described in EP 0 911 142 (incorporated by reference herein in its entirety). Powders whose median particle size is from 50 to 150 μm, these being obtained as in DE 197 08 946 (incorporated by reference herein in its entirety) or in DE 44 21454 (incorporated by reference herein in its entirety), are preferred.

A disadvantage of the prior art technique is that the non-irradiated parts of used polyamide powder have a tendency to undergo post-condensation under the conditions prevailing in the forming chamber of the laser sintering machine (high temperatures, very low moisture level).

As some studies have revealed, the reclaimed polyamide powders have markedly increased solution viscosity, and have only limited capability for use in the subsequent forming processes.

In order to achieve consistently good results in laser sintering, the prior art requires that the reclaimed powder is mixed with considerable amounts of virgin powder. The amount of virgin powder required is considerably higher than the amount consumed during the formation of the components. The result is that an excess of recycling powder must be used and has to be discarded since it can not be reused. In the case of filigree components, considerable amounts of recycling powder are formed in this way, and cannot then be used in further forming processes.

### SUMMARY OF THE INVENTION

Accordingly, it is an object of the present invention to provide a laser sintering powder which is suitable for direct reuse as a laser sintering powder with or without the addition of virgin powder, and thus to reduce the amount of recycling powder which has to be discarded.

Surprisingly, it has now been found that the addition of regulators to polyamides, in particular organic carboxylic acids to polyamides, permits the production of polyamide powders with almost constant solution viscosity, and that laser sintering powders which comprise these regulated polyamides can be used repeatedly in the laser sintering process without addition of virgin powders, or with the addition of only small amounts of virgin powder.

The present invention therefore provides a sinter powder for selective laser sintering, which comprises a polyamide having an excess of carboxy end groups, known as a regulated polyamide.

The present invention also provides a process for producing moldings by selective laser sintering of a sinter powder which comprises using a sintering powder which comprises a polyamide having an excess of carboxy end groups.

The present invention also provides moldings produced by selective laser sintering of sinter powders which comprise a regulated polyamide.

An advantage of the sintering powder of the invention is that it can be reused directly for laser sintering in the form of a recycling powder, mixed with only small amounts of virgin powder, or even without the addition of virgin powder. These excellent recycling qualities often render it unnecessary to discard recycling powders.

One reason for the excellent recycling qualities is that no increase in solution viscosity takes place on exposure to thermal stress. This may be associated with the regulated polyamides lower tendency toward post-condensation. In principle, the phenomenon of post-condensation is relevant to any of the polymers produced by condensation, i.e. polyesters, polyamides, etc. PA is particularly reactive in this respect. It has been found that if the number of carboxy end groups and the number of amino end groups are approximately the same, post-condensation can occur, thus altering the solution viscosity of the polyamide. End-group titration of the used powder, furthermore, shows that in many cases the loss of amino groups due to uncontrolled side reactions is more than stoichiometric in relation to carboxy groups. Thus indicating the presence of thermooxidative crosslinking reactions, which further impair the flowability of the used powder.

Conventional virgin powders used for laser sintering have a solution viscosity of about ηᵣₑₗ=1.6 according to ISO 307. As a result of thermal and thermooxidative stress (post-condensation+crosslinking) during laser sintering that may occur over a forming period that lasts two or more hours, in extreme cases several days, the non-irradiated sintering powder (recycling powder) exhibits poorer flow properties in many instances. If this recycling powder is directly used in laser sintering an increased number of defects and undesired pores occur in the moldings produced therefrom. The moldings have rough and indented surfaces (orange-peel effect), and have markedly poorer mechanical properties in terms of tensile strain at break, tensile strength, and modulus of elasticity, as well as reduced density.

In order to obtain satisfactory components complying with applicable specifications and having consistent quality, the recycling powder of the prior art has to be mixed with considerable amounts of virgin powder. The amount of the recycling powder usually used in the subsequent forming processes is from 20 to 70%. If the recycling powder also comprises fillers, e.g. glass beads, it is usually not possible to include more than 50% of the recycling powder. To ensure the abovementioned orange-peel effect does not occur, the company EOS, for example, recommends in its product information (material data sheet “Fine polyamide PA 2200 for EOSINT P”, March 2001) a ratio of 1:1, and not more than 2:1, of recycling powder to virgin powder.

The sintering powder of the invention is markedly less sensitive to the thermal stress that arises during laser sintering and can therefore be reused as recycling powder in laser sintering with or without admixture of virgin powder. This is also the case if the sinter powder comprises fillers. In all of these instances, the sinter powder of the invention has markedly improved recycling properties. One particular advantage is that complete recycling of the sinter powder is possible.

Another reason permitting the very effective reuse of the heat-aged powder of the invention is that, surprisingly, when the powder of the invention is heat-aged no decrease in recrystallization temperature is observed and in many instances a rise in the recrystallization temperature is observed. The result is that when the invention powder is aged and used to form a structure, the crystallization performance achieved is almost the same as that achieved using the virgin powder. The aged powder conventionally used hitherto crystallizes only at temperatures markedly lower than those for the virgin powder, and depressions can therefore occur when recycled powder is used for forming structures.

Another advantage of the sintering powder of the invention is that it can be mixed in any desired amounts (from 0 to 100 parts) with a conventional laser sintering powder containing an unregulated polyamide. When compared with sinter powder based on unregulated polyamide, the resultant powder mixture undergoes a smaller rise in solution viscosity, and exhibits improved recyclability.

### DETAILED DESCRIPTION OF THE INVENTION

The sinter powder of the invention is described below, as is a process which uses this powder without intention of limiting the invention.

The sinter powder of the invention for selective laser sintering comprises a polyamide with an excess of carboxy end groups, known as a regulated polyamide. It can be advantageous for the excess of carboxy end groups to be at least 20 mmol/kg.

Chemical analysis of a conventional powder exposed to thermal stress in a laser sintering process reveals a marked increase in solution viscosity resulting from molecular weight increase, and also a reduction in the number of amino end groups which is more than stoichiometric in relation to the reacted carboxy end groups. This may be caused by reaction of free amino end groups and carboxy end groups in the polyamide powder with one another to eliminate water. Under laser sintering conditions this reaction is known as post-condensation. The reduction in the number of amino functions also derives from the thermooxidative elimination of these groups with subsequent crosslinking. The effect of the regulator during the polymerization is that the number of free amino end groups is reduced. In the polyamide according to the invention, an excess of carboxy end groups is present.

The excess of carboxy end groups in the polyamide of the inventive sinter powder has a marked reduction, or complete elimination, in the increase in solution viscosity, and of the thermal oxidative loss of end groups.

The sinter powder of the invention preferably comprises a polyamide which preferably comprises from 0.01 part to 5 parts, even more preferably from 0.1 to 2 parts, of a mono- or dicarboxylic acid as regulator.

The sinter powder of the invention particularly preferably comprises a polyamide in which the ratio of carboxy end group to amino end group is 2:1 or higher. The content of amino end groups in this polyamide may be below 40 mmol/kg, preferably below 20 mmol/kg, and very preferably below 10 mmol/kg. The solution viscosity of the polyamide is preferably from 1.4 to 2.0 accordingly to ISO 307, particularly preferably from 1.5 to 1.8.

The sinter powder may also comprise a mixture of regulated and unregulated polyamide. When the sinter powder comprises a mixture of regulated and unregulated polyamide, the proportion of regulated polyamide in the mixture is preferably from 0.1 to 99.9%, more preferably from 5 to 95%, and very particularly preferably from 10 to 90%. Because it is also possible for the sinter powder to comprise a mixture of regulated and unregulated polyamide, previous inventories of unregulated sinter powder or unregulated recycling powder can be utilized.

In principle, the regulated polyamides useful in the invention sinter powders are any polyamides. However, it can be advantageous for the sinter powder to comprise a regulated nylon-12 or nylon-11. In particular, it can be advantageous for the sinter powder to comprise precipitated nylon-12. The preparation of precipitated nylon-12 is described in DE 29 06 647 (incorporated by reference herein in its entirety), for example. The sinter powder of the invention particularly preferably comprises precipitated nylon-12 powder with round particle shape, e.g., that which can be prepared in accordance with DE 197 08 946 or DE 44 21 454 (each of which is incorporated by reference herein in its entirety). The sinter powders of the invention very particularly preferably comprise a regulated nylon-12 with a melting point of from 185 to 189° C., with an enthalpy of fusion of 112±17 kJ/mol and with a freezing point of from 138 to 143° C., the unregulated form of which is described in EP 0 911 142 (incorporated by reference herein in its entirety).

The sinter powder of the invention preferably comprises one or more polyamides with a median particle size d₅₀ of from 10 to 250 μm, preferably from 30 to 100 μm, and very particularly preferably from 40 to 80 μm.

After the regulated sinter powder of the invention has undergone heat aging, there is preferably no shift in its recrystallization temperature (recrystallization peak in DSC) and/or in its enthalpy of crystallization to values smaller than those for the virgin powder. Heat-aging means exposure of the powder for from a few minutes to two or more days to a temperature in the range from the recrystallization temperature to a few degrees below the melting point. An example of typical artificial aging may take place at a temperature equal to the recrystallization temperature plus or minus approximately 5 K, for from 5 to 10 days, preferably for 7 days. Aging during use of the powder to form a structure typically takes place at a temperature which is 1 to 15 K below the melting point, preferably from 3 to 10 K, for from a few minutes to up to two days, depending on the time needed to form the particular component. In the heat-aging which takes place during laser sintering, powder which is not exposed to the laser beam is exposed to temperatures of only a few degrees below melting point during the forming procedure in the forming chamber. The preferred regulated sinter powder of the invention has, after heat-aging of the powder, a recrystallization temperature (a recrystallization peak) and/or an enthalpy of crystallization, which shift(s) to higher values. It is preferable that both the recrystallization temperature and the enthalpy of crystallization shift to higher values. A powder of the invention which is in the form of virgin powder has a recrystallization temperature above 138° C. very particularly preferably has, in the form of recycled powder obtained by aging for 7 days at 135° C., a recrystallization temperature higher, by from 0 to 3 K, preferably from 0.1 to 1 K, than the recrystallization temperature of the virgin powder.

The sinter powder may comprise, besides at least one regulated polyamide,. at least one filler. Examples of these fillers include glass particles, metal particles, or ceramic particles. The sinter powder may in particular comprise glass beads, steel shot, or granular metal as filler.

The median particle size of the filler particles is preferably smaller than or approximately the same as that of the particles of the polyamides. The amount by which the median particle size d₅₀ of the fillers exceeds the median particle size d₅₀ of the polyamide should preferably be not more than 20%, with preference not more than 15%, and very particularly preferably not more than 5%. The particle size is limited by the thickness o the layer in the particular laser sintering apparatus.

The sinter powder of the invention is preferably produced by the process described below for producing a sinter powder. In this process, a sinter powder is prepared from a polyamide, the polyamide used being a regulated polyamide, i.e. having an excess of carboxy end groups. Surprisingly, it has been found that if the starting material for preparing the virgin powder is a polyamide with an excess of carboxy end groups, the sinter powder obtained is completely recyclable and has forming properties approximately the same as those of a virgin powder. This polyamide preferably comprises from 0.01 part per 5 parts, with preference from 0.1 to 2 parts, of a mono- or dicarboxylic acid as regulator. The ratio of carboxy end group to amino end group in the regulated polyamide is preferably 2:1 or higher, preferably from 5:1 to 500:1, and particularly preferably from 10:1 to 50:1. It can be advantageous for the polyamide used to produce the sinter powder to have a content of amino end groups of less than 40 mmol/kg of polyamide, with preference less than 20 mmol/kg of polyamide, and very particularly preferably less than 10 mmol/kg of polyamide.

The preparation of the regulated polyamides is described below. The main features of the preparation of the regulated polyamides have been previously disclosed in DE 44 21 454 and DE 197 08 946 (each of which is incorporated by reference herein in its entirety). These polyamides are described as pelletized starting materials for reprecipitation to give fluidized-bed sinter powders.

Examples of suitable regulators include linear, cyclic, or branched, organic mono- and dicarboxylic acids having from 2 to 30 carbon atoms. By way of non-limiting examples of dicarboxylic acids, mention may be made of succinic acid, glutaric acid, adipic acid, 2,2,4-trimethyladipic acid, suberic acid, sebacic acid, dodecanedioic acid, brassylic acid, and terephthalic acid, and also mixtures of appropriate dicarboxylic acids. Examples of suitable monocarboxylic acids include benzoic acid, butyric acid, valeric acid, caproic acid, caprylic acid, capric acid, lauric acid, myristic acid, palmitic acid, and stearic acid. Particularly suitable mono- or dicarboxylic acids include those which have hydrocarbon chains whose length is from 6 to 30 carbon atoms. To permit problem-free use of the polyamides during laser sintering, it is preferable that no volatile carboxylic acids, in particular no carboxylic acids with a boiling point below 150° C., particularly preferably below 180° C., and very particularly preferably below 190° C., are used as regulators. The use of volatile carboxylic acids in laser sintering can in particular be disruptive if these remain in a form not chemically bonded within the sinter powder, because they volatilize during the sintering process and adversely affect the laser optics by fuming, and in the worst case can damage the equipment.

The term mono- or dicarboxylic acid is intended to encompass not only the free carboxylic acid functional group, but also all of the functional derivatives of the respective carboxylic acid, examples being acid halides, ester functions, amide functions, anhydrides, nitriles, or the corresponding carboxylate salts, each of which can be converted into the free carboxylic acid under the conditions of polymerization or polycondensation.

The regulator is advantageously introduced into the polyamide before polymerization is complete. This polymerization may start from the respective lactam, e.g. laurolactam, or from the appropriate ω-aminocarboxylic acid, e.g. ω-aminododecanoic acid.

However, for the purposes of the invention it is also possible for the regulator to be reacted in the melt or in the solid phase, or solution, with a high-molecular-weight polyamide, as long as the amino end groups are reacted to the extent described above under the reaction conditions. In principle, another possible method is the reaction of the polyamide with the regulator during the preparation of the polyamide by the precipitation process described in DE 29 06 647. In this precipitation process, nylon-12 is dissolved in a solvent, preferably ethanol, and crystallized from this solution under certain conditions. The regulator may be added during this process, e.g. into the solution of the nylon-12.

If a polyamide based on diamines and dicarboxylic acids is used, known as AABB polyamides, the synthesis takes place in a known manner, starting from solutions of the corresponding nylon salts, or from melts of the diamines and dicarboxylic acids. It can be advantageous here for the molten dicarboxylic acids to have been stabillized by addition of primary amines in accordance with DE 43 171 89 to inhibit discoloration.

According to the invention, in the case of an AABB type polyamide, the polyamide is prepared with an excess of carboxy end groups, and comprises from 0.01 part to 5 parts, preferably from 0.1 to 2 parts, of a mono- or dicarboxylic acid as regulator. The ratio of carboxy end group to amino end group in the AABB-type regulated polyamide is preferably 2:1 or higher, preferably from 5:1 to 500:1, particularly preferably from 10:1 to 50:1. In this case, it can again be advantageous for the AABB-type polyamide to have a content of amino end groups smaller than, 40 mmol/kg of polyamide, preferably smaller than 20 mmol/kg of polyamide, and very preferably smaller than 10 mmol/kg of polyamide. For regulation, use may again be made of any of the abovementioned carboxylic acids, and the carboxylic acid used here for regulation in the case of the AABB polyamide may also be the same as the dicarboxylic acid of the polyamide.

The regulated polyamide obtained is pelletized and then either milled or advantageously processed in accordance with DE 29 06 647, DE 19 708 946 or DE 4 421 454 (each of which is incorporated herein by reference), to give a precipitated powder.

The virgin powders used for laser sintering and prepared according to the process of the invention, and based on polyamide, typically have a solution viscosity of ηᵣₑₗ=from 1.4 to 2.0, preferably a solution viscosity of ηᵣₑₗ=from 1.5 to 1.8, according to ISO 307, using 1%-phosphoric acid-doped m-cresol as solvent and 0.5% by weight of polyamide, based on the solvent. If the laser sinter powder of the invention comprises from 0.01 part to 5 parts, preferably from 0.1 to 2 parts, of a mono- or dicarboxylic acid as regulator, the solution viscosity and the amino end group content of the recycling powder are nearly the same as those of the virgin powder, and the recycling powder can therefore be reprocessed after sieving.

The recycling powder obtained from the use of a virgin powder produced according to the invention preferably has a content of amino end groups smaller than 40 mmol/kg of polyamide, with preference smaller than 20 mmol/kg of polyamide, and very particularly preferably smaller than 10 mmol/kg of polyamide, corresponding to the particular specifications selected for the virgin powder.

To produce the sinter powder, it can be advantageous to produce a mixture which comprises not only regulated polyamide powder as virgin powder but also regulated polyamide powder as recycling powder. It is also possible for the sinter powder produced to be a mixture which comprises not only regulated polyamide powder but also unregulated polyamide powder. It can also be advantageous far the sinter powder which comprises not only regulated polyamide but also various fillers, e.g. glass particles, ceramic particles, or metal particles. Examples of typical fillers include granular metals, steel shot, and glass beads.

The median particle size of the filler particles is preferably smaller than or approximately the same as that of the polyamides particles. The amount by which the median particle size d₅₀ of the fillers exceeds the median particle size d₅₀ of the polyamide should preferably be not more than 20%, with preference not more than 15%, and very particularly preferably not more than 5%. The particle size arises is limited by the height or thickness of layers in the laser sintering apparatus. Typically, glass beads with a median diameter of from 20 to 80 μm are used.

The sinter powder of the invention is preferably used in a process for producing moldings by selective laser sintering of sinter powder, which comprises using a sinter powder which comprises polyamide with an excess of carboxy end groups, known as a regulated polyamide.

The sinter powder used in this process preferably comprises a regulated polyamide having a ratio of carboxy end groups to amino end groups of greater than 2:1, an amino end group content smaller than 40 mmol/kg, and a relative solution viscosity of from 1.4 to 2.0 according to ISO 307. The sinter powder may comprise at least nylon-11 and/or nylon-12.

It can be advantageous for the invention process to use a sinter power which comprises a polyamide regulated by mono- or dicarboxylic acids, or derivatives thereof. The sinter powder may comprise a polyamide regulated by one or more linear, cyclic, or branched organic mono- or dicarboxylic acids, or by derivatives thereof having from 2 to 30 carbon atoms.

The process of the invention for laser sintering preferably uses a sinter powder which comprises a polyamide powder with a relative solution viscosity of from 1.5 to 1.8 according to ISO 307.

It has proven particularly advantageous for the process of the invention to use a sinter powder which comprises from 0.01 to 5% by weight, preferably from 0.1 to 2% by weight, based on the polyamide used, of the carboxylic acid used for regulation, and whose content of amino end groups is less than 20 mmol/kg, preferably less than 10 mmol/kg of polyamide.

One method of carrying out the process uses a sinter powder which comprises a mixture of regulated and unregulated polyamide powder, the proportion of regulated powder in the mixture may be from 0.1 to 99.9%, preferably from 5 to 95%, particularly preferably from 25 to 75%.

The sinter powder used in the process of the invention which comprises a regulated polyamide may be a virgin powder, a recycling powder, or a mixture of virgin powder and recycling powder. It can be advantageous for the process to use sinter powders comprising recycling powder, or comprising a mixture of recycling powder and virgin powder, the proportion of virgin powder in the mixture may be smaller than 50%, preferably smaller than 25%, and very particularly preferably smaller than 10%. It is particularly preferable to use sinter powder which comprises at least 40% by weight of recycling powder.

The sinter powder may further comprise fillers, preferably inorganic fillers. Examples of these inorganic fillers include glass particles, ceramic particles, or glass beads.

The process of the invention, and the use of the sinter powder of the invention, provide access to moldings produced by selective laser sintering that comprises a regulated polyamide. In particular, moldings which comprise a regulated nylon-12 are accessible. It is also possible to obtain moldings which comprise a mixture of regulated and unregulated polyamide, the proportion of regulated polyamide in the polyamide mixture may be from 0.1 to 100%.

The moldings of the invention may in particular also be produced by using a sinter powder of the invention in the form of aged material (aging as described above), where neither the recrystallization peak of this material nor its enthalpy of crystallization is smaller than those of the unaged material. A molding of the invention is preferably produced using an aged material having a recrystallization peak and enthalpy of crystallization which are higher than those of the unaged material. Despite the use of recycled powder, the properties of the moldings are almost the same as those of moldings produced from virgin powder.

The production of moldings which comprise regulated polyamide, in particular regulated nylon-12, is substantially more environmentally compatible and cost-effective, because it is possible to use all of the recycling powder to produce moldings.

The examples below relating to the aging performance of the polyamide powder are intended to provide further illustration of the invention and are not intended to further limit the invention.

### EXAMPLE 1

Reprecipitation of Unregulated Nylon-12 (PA12) in Accordance with DE-A 3510690

400 kg of unregulated PA 12 prepared by hydrolytic polymerization of laurolactam, with a relative solution viscosity ηᵣₑₗ of 1.60 (in acidified m-cresol), and with an end group content [COOH]=72 mmol/kg and [NH₂]=68 mmol/kg were heated to 145° C. over a period of 5 hours in a 3 m³ stirred tank (d=160 cm) with 2,500 1 of ethanol, denatured with 2-butanone and 1% water content, and held for one hour at this temperature, with stirring (blade stirrer, d=80 cm, rotation rate=85 rpm).

The jacket temperature was then reduced to 124° C., and the internal temperature was brought to 125° C., using a cooling rate of 25 K/h, and the same stirrer rotation rate with continuous removal of the ethanol by distillation. From this juncture onward, the jacket temperature was held below the internal temperature by from 2 to 3 K, using the same cooling rate, until onset at 109° C. of the precipitation, detectable via evolution of heat. The distillation rate was increased in such a way that the internal temperature did not rise above 109.3° C. After 20 minutes, the internal temperature falls, indicating the end of the precipitation. The temperature of the suspension was brought to 45° C. via further removal of material by distillation, and cooling by way of the jacket, and the suspension was then transferred into a paddle dryer. The ethanol was removed by distillation at 70° C./400 mbar, and the residue was then further dried for 3 hours at 20 mbar and 85° C.

Sieve analysis gave the following values:

<32 μm: 8% by weight

<40 μm: 17% by weight

<50 μm: 26% by weight

<63 μm: 55% by weight

<80 μm: 92 % by weight

<100 μm: 100% by weight

The bulk density of the product was 433 g/l.

### EXAMPLE 2

Reprecipitation of Regulated PA 12

The experiment of example 1 was repeated, using PA 12 pellets which had been obtained by hydrolytic laurolactam polymerization in the presence of 1 part of dodecanediol acid per 100 parts of laurolactam: ηᵣₑₗ=1.55, [COOH]=132 mmol/kg, [NH₂]=5 mmol/kg. Except for the stirrer rotation rate (100 rpm), the conditions for solution, precipitation, and drying are those selected in example 1. The bulk density of the product was 425 g/l.

Sieve analysis gave the following values:

<32 μm: 8% by weight

<40 μm: 27% by weight

<50 μm: 61% by weight

<63 μm: 97% by weight

<90 μm: 100 by weight

### EXAMPLE 3 (Inventive)

The unregulated polyamide powder from example 1 was mixed in a ratio of 1:1 with the regulated polyamide powder from example 2. The ηᵣₑₗ of the mixture is 1.58.

### EXAMPLE 4 (Comparative)

The powder from example 1 was treated in a ratio of 3:2 with glass beads (from 40 to 80 μm) as filler, and mixed.

### EXAMPLE 5 (Inventive)

Using a method similar to that of example 4, the powder from example 2 was treated in a ratio of 3:2 with glass beads (from 40 to 80 μm) as filler, and mixed.

### EXAMPLE 6

The thermal erects arising during laser sintering were simulated in a shortened period, using heat-conditioning experiments in a drying cabinet at 160° C. The sinter powders from examples 1 to 5 were used. Table 1 gives the ηᵣₑₗ values related to post-condensation as a function of the duration of the heat-conditioning experiments:

TABLE 1
Heat-conditioning experiments at 160° C. in a
drying cabinet (example 6)

| | ηᵣₑₗ starting | ηᵣₑₗ after | ηᵣₑₗ after | ηᵣₑₗ after |
|---|---|---|---|---|
| Example | point | 1 h | 4 h | 8 h |
| 1 (comparison) | 1.60 | 1.82 | 2.20 | 2.30 |
| 2 | 1.55 | 1.55 | 1.58 | 1.62 |
| 3 | 1.58 | 1.62 | 1.74 | 1.79 |
| With glass beads | | | | |
| 4 (comparison) | 1.63 | 1.92 | 2.45 | 3.19 |
| 5 | 1.61 | 1.78 | 1.86 | 1.94 |

From the examples it can be seen that the sinter powders of the invention, as in examples 2, 3 and 5, all of which comprise a regulated polyamide, give a markedly smaller rise in solution viscosity than the sinter powder of the prior art. Even after an experimental period of 8 hours, the solution viscosity of the sinter powders of the invention is smaller than 2, and they could therefore be reused in the form of recycling powder for laser sintering.

Examples 7 and 8 indicate the alteration of solution viscosity of regulated and unregulated nylon-12 powder as a function, of the forming period during laser sintering. Example 8 indicates the alteration of solution viscosity for a mixture of regulated and unregulated material during laser sintering.

### EXAMPLE 7 (Comparative Example)

A sinter powder was produced as in example 1, and used in a laser sintering system (EOSINT P 350, from the company EOS GmbH, Planegg, Germany). After a forming period of 30 h, the solution viscosity ηᵣₑₗ was 1.94, and after 65 h was 2.10.

### EXAMPLE 8 (Inventive)

A sinter powder was produced as in example 2, and used in a laser sintering system (EOSINT P 350, from the company EOS GmbH, Planegg, Germany). After a forming period of 70 h, the solution viscosity ηᵣₑₗ of the recycling powder was 1.59.

The recycling powder from example 8 can, unlike the recycling powder from example 7, be directly reused for laser sintering after a precautionary sieving, using a sieve with mesh width 200 μm.

### EXAMPLE 9 (Inventive)

A mixture was prepared in a ratio of 1:1 by weight, from regulated sinter powder as in example 2 and unregulated material as in example 1, and used as in examples 7 and 8. The solution viscosity ηᵣₑₗ of the mixture was 1.57. After a forming period of 45 h, the solution viscosity ηᵣₑₗ was 1.74.

The mixture made from sinter powder with regulated polyamide and sinter powder with unregulated polyamide has substantially greater solution viscosity stability than the sinter powder of example 7.

### EXAMPLES 10 a-c (Comparative Examples) 10 d (Inventive)

Heat-Conditioning and Thermal Stress in Rotary Flask:

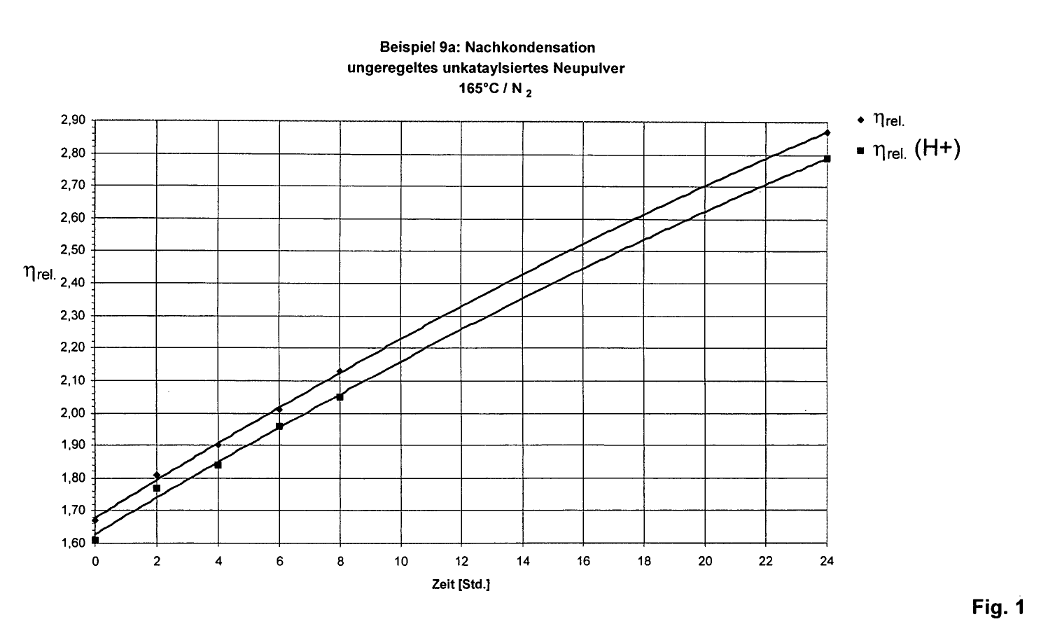

For example 10 a, a powder prepared as in example 1 was used unaltered. For examples 10 b and c, 0.1 % by weight of hypophosphorous acid and 0.5% by weight of orthophosphoric acid were added to the suspension during the drying process. For example 10 d, a specimen as in example 2 was provided with the same acid addition. For the modeling experiments, in each case a 100 g specimen of the dried powders was kept at 165° C. for 24 hours in a rotary flask under a constant 5 l/h stream of nitrogen. The increase in the solution viscosities in neutral and, respectively, phosphoric-acid-doped, m-cresol is followed (table 2, FIGS. 1-3), and the use of acidic and, respectively, basic end groups is compared (table 2). As can be seen from the table and from FIGS. 1 to 3, the only specimen whose end group contents and solution viscosity do not alter over the entire test period is that of example 10 d.

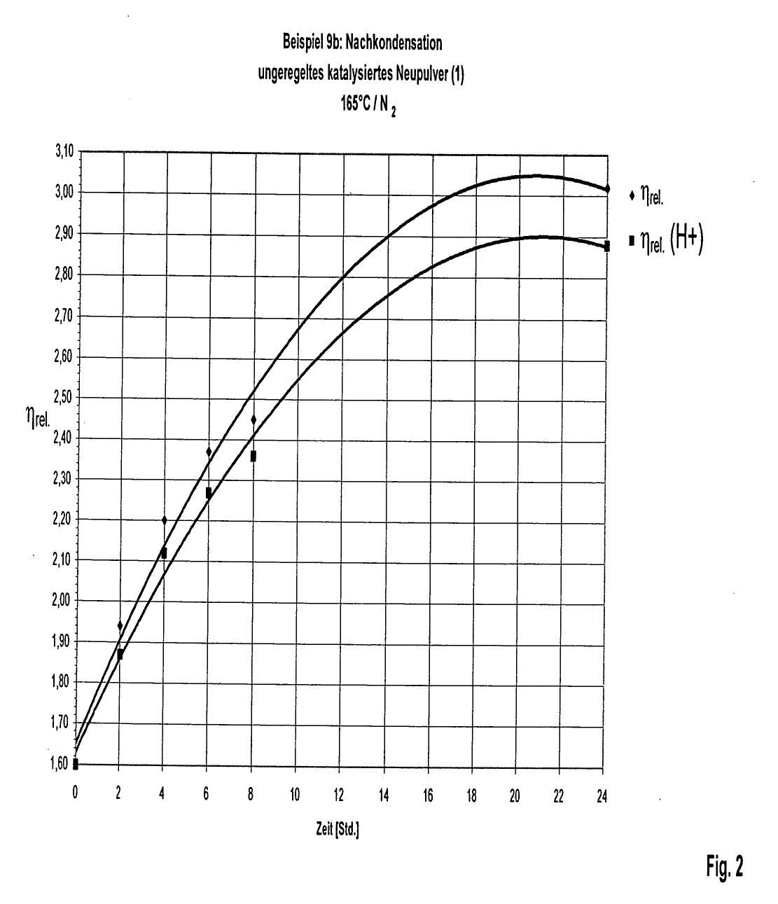

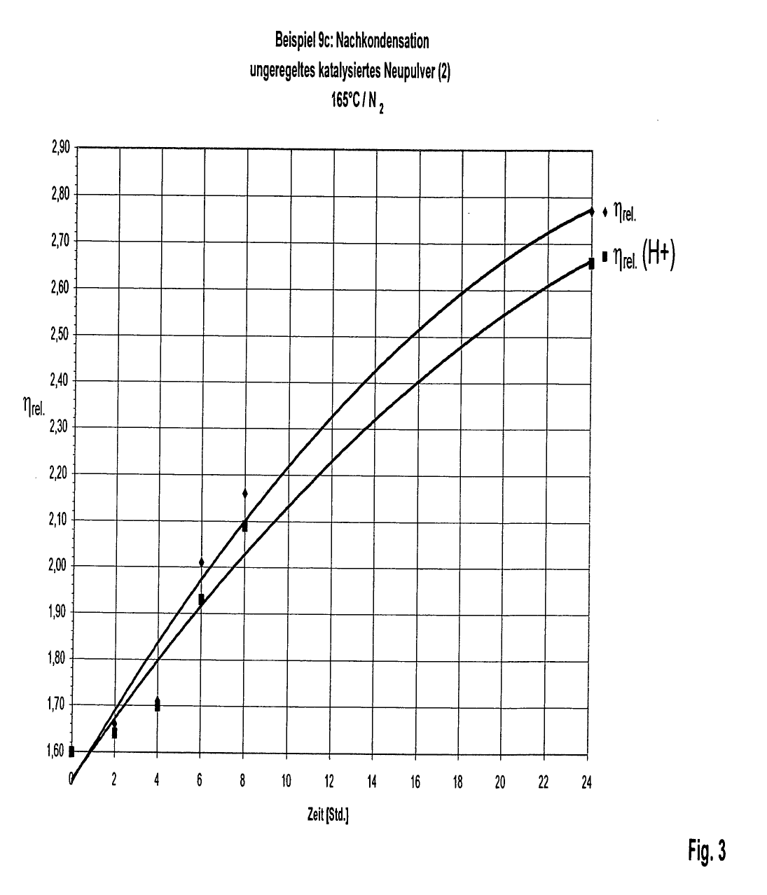

FIGS. 1 to 3 show the variation in solution viscosities as a function of heat-conditioning period. FIG. 1 shows the curve for the powder of example 10 a. FIG. 2 shows the curve for the powder of example 10 b. FIG. 3 shows the curve for the powder of example 10 c. The graph of the results from example 10 b has been omitted, because no significant change in solution viscosity could be found over the period of the experiment.

TABLE 2
Heat-conditioning experiments at 165° C. in example 10:

| | Specimen | | | | | | | |
|---|---|---|---|---|---|---|---|---|
| | Experiment 10a | | Example 10b | | Example 10c | | Example 10d | |
| | Uncatalyzed | | Catalyzed | | Catalyzed | | Catalyzed | |
| | Unregulated | | unregulated | | unregulated | | Regulated | |
| Time | 0 | 24 | 0 | 24 | 0 | 24 | 0 | 24 |
| ηᵣₑₗ | 1.67 | 2.87 | 1.60 | 3.02 | 1.60 | 2.77 | 1.60 | 1.61 |
| ηᵣₑₗ (H+) | 1.61 | 2.79 | 1.60 | 2.88 | 1.60 | 2.66 | 1.60 | 1.59 |
| COOH | 61.40 | 19.80 | 143.00 | 117.00 | 148.00 | 131.00 | 112.00 | 114.00 |
| | 64.40 | 19.90 | 143.00 | 117.00 | 148.00 | 132.00 | 113.00 | 111.00 |
| NH₂ | 59.90 | 11.00 | 54.00 | 2.00 | 57.00 | 0.00 | 8.00 | 7.00 |
| | 60.30 | 11.90 | 54.00 | 2.20 | 57.00 | 2.20 | 9.00 | 11.00 |
| Time | 0 | 24 | 0 | 24 | 0 | 24 | 0 | 24 |
| Total | 123.00 | 31.30 | 197.00 | 119.10 | 205.00 | 132.60 | 121.00 | 121.50 |
| Difference | 2.80 | 18.40 | 89.00 | 114.90 | 91.00 | 130.40 | 104.00 | 103.50 |

### EXAMPLE 11

Aging Experiments

For artificial heat-aging, the powder from example 1 and example 2 was aged artificially in a vacuum drying cabinet at 135° C. for 7 days.

The powder of the invention was further studied by using DSC equipment (Perkin Elmer DSC 7) to carry out DSC studies to DIN 53765 on powder produced according to the invention, and also specimens of components. The results of these studies are given in table 3.

TABLE 3
Results of Aging Experiments

| | | Enthalpy | Recrystal- | |
|---|---|---|---|---|
| | Melting | of | lization | Enthalpy of |
| | Peak | fusion | peak | recrystallization |
| | ° C. | J/g | ° C. | J/g |
| Powder from | 187.5 | 126.6 | 143.4 | 78.4 |
| example 2, virgin | | | | |
| Powder from | 187.5 | 128.8 | 144.3 | 78.9 |
| example 2 after | | | | |
| heat aging | | | | |
| Powder from | 188.4 | 124.2 | 138.4 | 64.9 |
| example 1, virgin | | | | |
| Powder from | 192.2 | 124.9 | 133.1 | 59.0 |
| example 1 after | | | | |
| heat aging | | | | |

As is clear from the results in table 3, the powder of the invention as in example 2 has, after the aging process, a recrystallization temperature (recrystallization peak) which is even higher than the recrystallization temperature of the virgin material. In contrast, the known unregulated comparative powder of example 1 shows a marked decrease in recrystallization temperature after the aging process.

German applications 10248407.4 and 10330590.4 filed on Oct. 17, 2002 and Jul. 7, 2003 respectively are incorporated herein by reference in their entireties.

Obviously, numerous modifications and variations of the present invention are possible in light of the above teachings. It is therefore to be understood that within the scope of the appended claims, the invention may be practiced otherwise than as specifically described herein.

1. A sinter powder for selective laser sintering comprising a polyamide having an excess of carboxy end groups.

2. The sinter powder as claimed in claim 1, comprising a polyamide having a ratio of carboxy end groups to amino end groups greater than 2:1, having an amino end group content of below 40 mmol/kg, and having a relative solution viscosity of from 1.4 to 2.0 according to IS0307.

3. The sinter powder as chimed in claim 1, comprising a regulated nylon-12.

4. The sinter powder as claimed in claim 1, comprising a mixture of regulated and unregulated polyamide.

5. The sinter powder as claimed in claim 4, wherein the regulated polyamide is present in an amount of 0.1 to 99.9%.

6. The sinter powder as claimed in claim 1, further comprising at least one filler.

7. The sinter powder as claimed in claim 1, comprising glass particles.

8. The sinter powder as claimed in claim 1, further comprising from 5 to 100% of recycling powder, wherein said recycling powder is a non-irradiated powder obtained from a laser sintering process.

9. The sinter powder as claimed in claim 1, wherein the recrystallization peak, the enthalpy of crystallization of the powder, or both, does not have a smaller value after heat-aging of the powder than the values before heat-aging.

10. The sinter powder as claimed in claim 1 wherein the recrystallization peak, the enthalpy of crystallization, or both, has a higher value after heat-aging of the powder than the value before heat-aging.

11. A process for producing moldings comprising:
sintering a powder which comprises at least one polyamide having an excess of carboxy end groups,
wherein sintering includes selective laser sintering.

12. The process as claimed in claim 11, wherein the polyamide has a ratio of carboxy end groups to amino end groups of greater than 2:1, an amino end group content of below 40 mmol/kg, and a relative solution viscosity of from 1.4 to 2.0 according to IS0207.

13. The process as claimed in claim 11, wherein the resin powder comprises at least one of nylon-11 or nylon-12.

14. The process as claimed in claim 11, wherein the sinter powder comprises a polyamide regulated by at least one of a mono- or dicarboxylic acid, or a derivative thereof.

15. The process as claimed in claim 14, wherein the sinter powder comprises a polyamide regulated by one or more linear, cyclic, or branched organic mono- or dicarboxylic acids, or a derivative thereof having from 2 to 30 carbon atoms.

16. The process as claimed in claim 11, wherein the sinter powder comprises a polyamide powder having a relative solution viscosity of from 1.5 to 1.8 according to ISO 307.

17. The process as claimed in claim 11, wherein the sinter powder comprises a polyamide comprising a carboxylic acid in an amount of from 0.01 to 5% by weight, based on the weight of the polyamide, and less than 20 mmol/kg of amino end groups.

18. The process as claimed in claim 17, wherein the sinter powder comprises a polyamide comprising a carboxylic acid in an amount of from 0.1 to 2% by weight, based on the polyamide, and a content of less than 10 mmol/kg of amino end groups.

19. The process as claimed in claim 11, wherein the sinter powder comprises a mixture of regulated and unregulated polyamide powder, and the proportion of regulated powder in the mixture is from 0.1 to 99.9%.

20. The process as claimed claim 11, wherein the sinter powder further comprises one or more inorganic fillers.

21. The process as claimed in claim 11, wherein the sinter powder further comprises glass beads.

22. The process as claimed in claim 11, wherein the sinter powder comprises from 5 to 100% of a recycling powder.

23. A molding produced by selective laser sintering of a sinter powder which comprises a regulated polyamide.

24. The molding as claimed in claim 23, which comprises a regulated nylon-12.

25. The molding as claimed in claim 23, which comprises a mixture of regulated and unregulated polyamide, wherein the proportion of regulated polyamide in the mixture is from 0.1 to 100%.

26. The molding as claimed in claim 23, obtained by sintering on aged sinter powder having neither a recrystallization peak value nor a enthalpy of crystallization value smaller than the values of the unaged sinter powder.

27. The molding as claimed in claim 26, wherein the aged sinter powder has a recrystallization peak value and an enthalpy of crystallization value higher than the values of the unaged sinter powder.

28. A process for producing the sinter powder as claimed in claim 1, comprising treating an unregulated polyamide with a carboxylic acid to form a regulated polyamide.

29. The process as claimed in claim 28, wherein treating includes reaction of the unregulated polyamide during polymerization.

30. The process as claimed in claim 28, wherein treating includes reaction of a high-molecular-weight polyamide with a regulator in the melt, in the solid phase, or in solution.
